(19) United States
(12) Patent Application Publication
(10) Pub. No.: US 2016/0131867 A1
(43) Pub. Date: May 12, 2016

(54) AUTOMATIC FOCUSING OPTICAL ASSEMBLY, SYSTEM AND METHOD

(71) Applicant: OCUTECH, INC., Chapel Hill, NC (US)

(72) Inventors: Henry A. Greene, Durham, NC (US); Robert Hart, Cary, NC (US); Scott Elliott, Holly Springs, NC (US); Jeffery Denton, Holly Springs, NC (US)

(21) Appl. No.: 14/933,610

(22) Filed: Nov. 5, 2015

Related U.S. Application Data
(60) Provisional application No. 62/076,104, filed on Nov. 6, 2014.

(51) Int. Cl. G02B 7/28; G02B 13/14; G02B 5/28; G02B 5/04; G02B 27/14; G02B 7/09

(52) U.S. Cl. CPC G02B 7/28; G02B 27/141; G02B 7/09; G02B 5/281; G02B 5/04; G02B 13/14

(57) ABSTRACT

An automatic focusing optical system and assembly including an objective lens subassembly, a sensor electronically connected to a processor, and a dichroic filter for passing light of a first wavelength to the sensor and reflecting light of a second wavelength. A method of auto-focusing including receiving an image of an object comprising a first wavelength and a second wavelength, wherein the first wavelength is passed through a dichroic filter to a sensor and the second wavelength reflected, analyzing the distance of the object based on the first wavelength, generating at least one signal to an objective lens subassembly comprising a drive mechanism arranged to displace an optical lens, and displacing an optical lens along an optical axis to focus the image.

### CROSS-REFERENCE TO RELATED APPLICATION

This application claims the benefit of U.S. Provisional Application No. 62/076,104, filed Nov. 6, 2014, the contents of which are incorporate by reference in their entirety.

### FIELD OF THE INVENTION

This invention relates generally to auto focusing optical assemblies, systems and methods.

### BACKGROUND

Vision enhancing devices (i.e., optical assemblies) facilitate magnifying and/or focusing on visual objects selected by a user. Optical assemblies are used by a variety of people for a variety of purposes. Such individuals and purposes include, but are not limited to, low vision individuals, people engaged in detailed work generally in professional fields surgeons, dentists, gemologists, researchers, and archeologists), and individuals using such devices for surveillance, security, entertainment, recreational, and sporting purposes (e.g., hunting and spectator sports). Optical assemblies may be described as binoculars, bioptics, vision aids, telescopes, or loupes. Many vision impaired individuals with conditions such as macular degeneration rely heavily on such optical assemblies.

Many optical assemblies are mounted onto or into a lens of a spectacle (e.g., eye glasses or sun glasses). Such optical systems are typically fixed focus or manually adjustable over useable imaging ranges from infinity to approximately 10 inches. Known auto focusing systems generally have too many limitations to be utilized with the optical assemblies described herein. For example, auto focusing systems tend to be large and heavy when compared with existing manually adjustable focusing systems, and therefore would cause wear fatigue in a short period of time. The size and weight limitations are likely a result of the limited availability of small and lightweight distance measuring components and subsystems. Current auto focus systems rely on optical or ultra-sonic range finders to collect object distance information used to focus the system. Again, such range finders tend to be far too bulky and heavy for broad range applicability of optical systems.

Accordingly, there remains a need for an auto focusing optical assembly, system and method. A known optical assembly is represented in FIG. 1 and FIG. 2, commercially available as the Ocutech Sport 4X manual focus device. In FIG. 1, a partially exploded view (not to scale) of a prior art vision enhancing optical assembly 10 is provided and reveals a light path 26 that enters the assembly 10 through a window 20 often made of glass, reflected off a fold mirror 21 towards the objective lens 22 that is manually movable for manual focus adjustment. The window 20 protects the internal components of the optical assembly 10 from environmental elements. The light path 26 passes through the objective lens 22 to the combination penta/roof prism 23 where the light path reflects off a first 23.1 and second 23.2 edge towards a relay lens (eyepiece lens assembly) 24 and out to the user's eye 25.

Generally, the assembly 10 comprises a single moving objective lens 22 on a rack and pinion mechanism (not shown) allowing for positional changes of the objective lens 22 in the horizontal plane relative to the light path 26 between the fold mirror 21 and the combination penta/roof prism 23. The image plane traversing the light path 26 is redirected and inverted internally by the combination penta/roof prism 23, where it is then relayed to a users eye 25 often through an adjustable relay lens system 24.

With respect to FIG. 2, the optical assembly 33 has a slim profile which is easily attached to a standard spectacle frame (not shown). Manual adjustment of focus is made via the focusing wheel 31 located adjacent the protective window 30. The relay lens 32 provides a collimated output and is generally placed in front of or through a user's spectacle lens (not shown) which may contain additional lenses to correct the refractive error of a patient's eye. The assembly 31 is designed for the device to be used for either the left or right eye of the patient by simply inverting the device.

### SUMMARY

It should be appreciated that this Summary is provided to introduce a selection of concepts in a simplified form, the concepts being further described below in the Detailed Description. This Summary is not intended to identify key features or essential features of this disclosure nor is it intended to limit the scope of the invention.

The present invention relates to an automatic focusing optical assembly, system and method. According to some embodiments of the present invention, an automatic focusing system comprises a dichroic or interference filter to separate the visible band of the electromagnetic spectrum from the infrared band, wherein the infrared band is directed to a sensor and the visible band is directed to the eyepiece for the user. In some embodiments, the invention relates to an automatic focusing optical assembly comprising an interference or dichroic filter. In some embodiments, the invention relates to a method of auto-focusing comprising by filtering wavelengths for sensing.

According to some embodiments of the present invention, an automatic focusing optical system comprises an objective lens subassembly, a sensor electronically connected to a processor, and a dichroic filter for passing light of a first wavelength to the sensor and reflecting light of second wavelength(s).

According to some embodiments of the present invention, an automatic focusing vision enhancing optical assembly comprises an objective lens subassembly, an infrared sensor electronically connected to a processor, an eyepiece lens, and a dichroic filter for passing light of a first wavelength to the infrared sensor and reflecting light of a second wavelength towards the eyepiece lens.

According to some embodiments of the present invention, a method of auto-focusing by filtering wavelengths for sensing, the method comprises receiving an image of an object, wherein the first image comprises a first wavelength and a second wavelength, wherein the first wavelength is passed through a dichroic filter to a sensor and the second wavelength reflected, analyzing the distance of the object based on the first wavelength, generating at least one signal to an objective lens subassembly comprising a drive mechanism arranged to displace an optical lens, and displacing an optical lens along an optical axis to focus the image. Also an adjustable focus lens placed in front of the objective lens that will change the focus of the system without requiring movement of the objective lens.

Other aspects, features and embodiments of the invention will be more fully apparent from the ensuing specification and claims.

### BRIEF DESCRIPTION OF THE FIGURES

FIG. 1 is a partially exploded view of a prior art vision enhancing optical assembly.

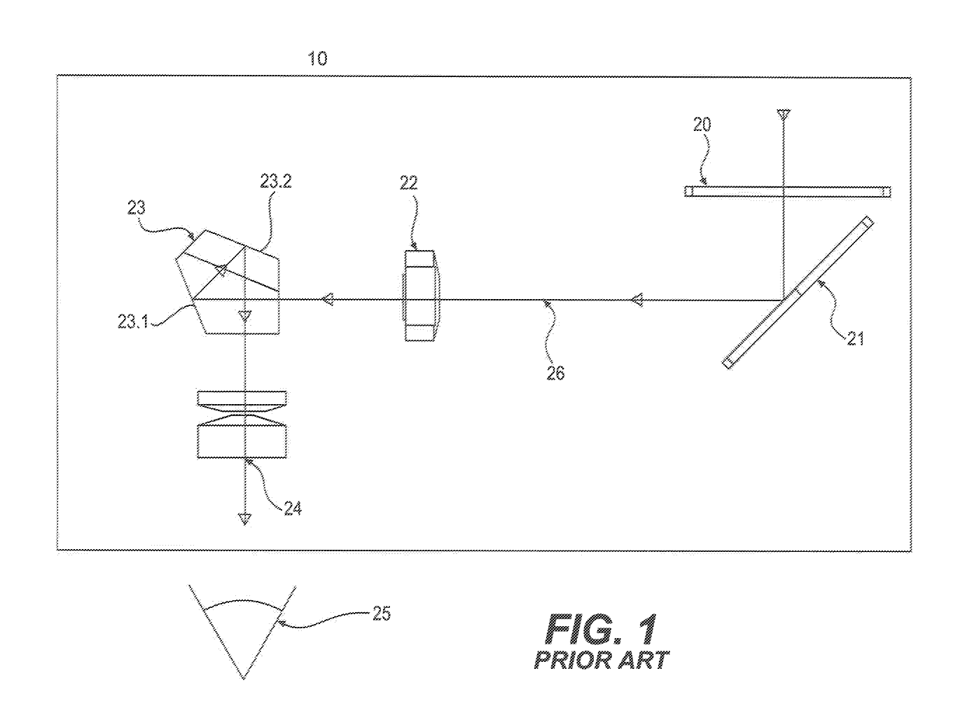

FIG. 2 is a perspective view of a prior art vision enhancing optical assembly.

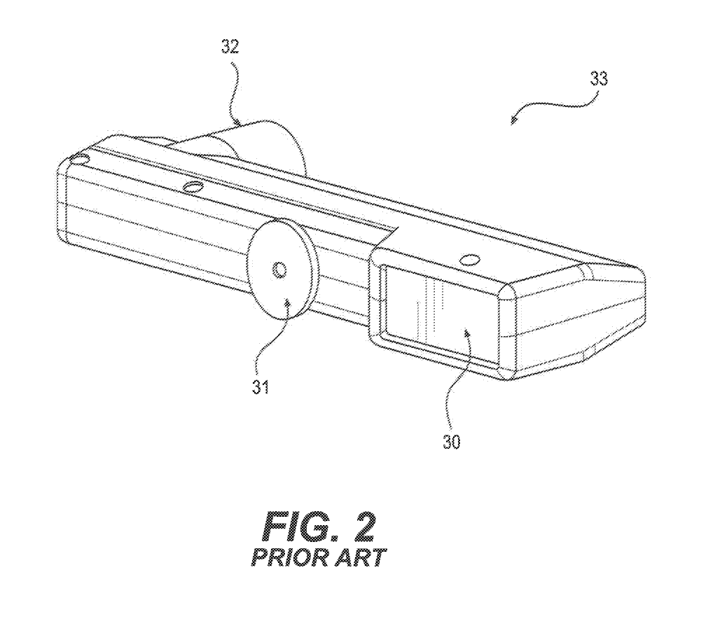

FIG. 3 is a partially exploded perspective view of the optical support assembly according to some embodiments.

FIG. 4 is a perspective view of a portion of an objective lens subassembly according to some embodiments.

FIG. 5 is a flowchart showing an algorithm for focusing an image using first wavelength luminance data, according to some embodiments.

### DETAILED DESCRIPTION OF EMBODIMENTS OF THE INVENTION

The invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

As used herein, the terms “comprising” or “comprises,” “including” or “includes,” and “having” or “has” are open-ended, and include one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items.

As used herein, the common abbreviation which derives from the Latin phrase “exempli gratia,” may be used to introduce or specify a general example or examples of a previously mentioned item, and is not intended to be limiting of such item. If used herein, the common abbreviation “i.e.,” which derives from the Latin phrase “id est,” may be used to specify a particular item from a more general recitation.

The terminology used herein is for the purpose of describing particular embodiments only and is not intended to be limiting of the invention. As used herein, the singular forms “a,” “an” and “the” are intended to include the plural forms as well, unless the context clearly indicates otherwise.

Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having as meaning that is consistent with their meaning in the context of the relevant art and will not be interpreted in an idealized or overly formal sense unless expressly so defined herein.

In addition, spatially relative terms, such as “under,” “below,” “lower,” “over,” “upper,” “downward,” “upward,” “inward, “outward” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below

The term “sensor” as used herein generally refers to any electro-optical sensor used to detect light and create an electronic signal. In some embodiments, the sensor is an autofocus infrared sensor that is electronically connected to a processor that, through software and/or algorithms, displaces an objective lens, or other components that may change the focus of the apparatus.

The terms “drive” or “drive mechanism” as used herein generally refers to any mechanism, motor, or other device capable of displacing or moving the objective lens that may include, but is not limited to, an electronically controlled actuator. In some embodiments, the drive or drive mechanism includes a piezo actuator. In some embodiments, the input signal for the actuator is derived from the sensor, software, and/or one or more algorithms to determine edge sharpness in a selected region of interest and/or generate the required signals to drive the objective lens to a focus inflection point. In some embodiments, the drive mechanism comprises a piezo actuator for receiving an electronic signal from the processor and/or sensor and displacing an objective lens of the objective lens subassembly.

The term “back facet dichroic coating” as used herein generally refers to a dichroic filter that in some embodiments replaces the reflective layer on one surface of the combination penta/roof prism. In some embodiments, the back facet dichroic coating acts as an optical long pass filter separating the visible band of the electromagnetic spectrum from the near infrared band of the electromagnetic spectrum. In some embodiments, the prism provides a right angle fold and vertical flip of the visible image while the dichroic coating provides a pass through for the near infrared region of the spectrum which propagates the infrared wavelengths unperturbed through the prism to a sensor.

According to some embodiments of the present invention, an automatic focusing vision enhancing optical assembly includes an objective lens subassembly, an infrared sensor electronically connected to a processor, an eyepiece lenses, and a dichroic filter for passing light of a first wavelength to the infrared sensor and reflecting light of a second wavelength towards the eyepiece lens. In some embodiments, the dichroic filter is part of or incorporated into a pentaprism. In some embodiments, the auto focus assembly and system comprise the following components and subassemblies: an objective lens focus subassembly, a combined penta/roof prism, a relay lens system, near infrared imaging subassembly, system electronics and rechargeable battery pack. In some embodiments, image processing software, electronics and/or algorithms are used to determine the proper direction to drive the system's objective lens to the proper focus position for the user.

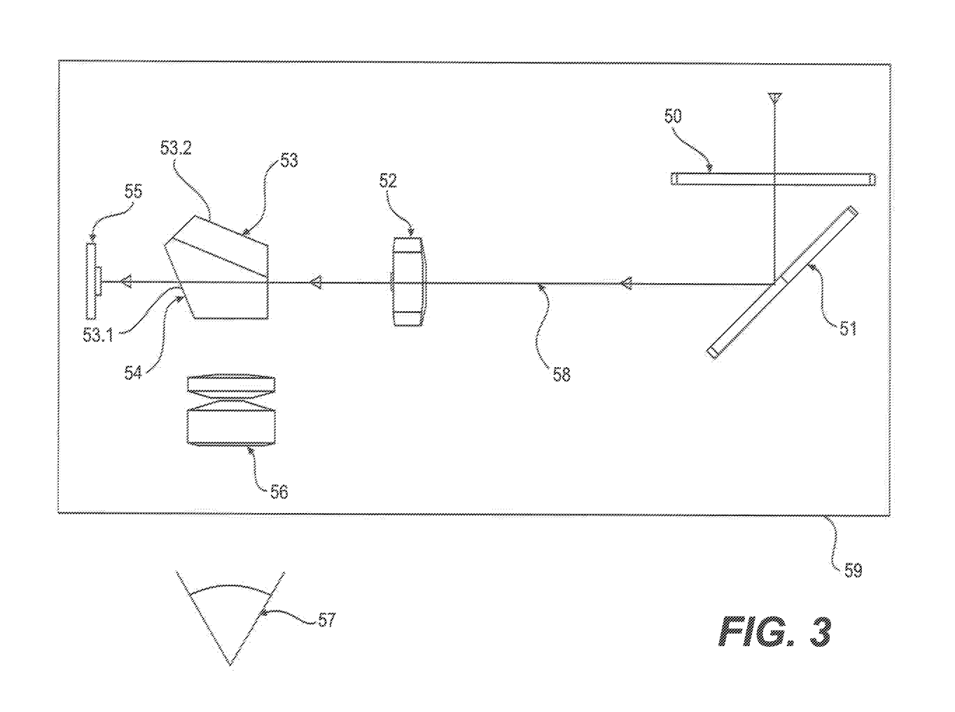

In FIG. 3, a partially exploded view (not to scale) of one embodiment of the present invention vision enhancing optical assembly (outlined for illustration purposes only within the box 59) is provided and reveals a light path 58 that enters the assembly 59 through a window 50 often made of glass, reflected off a fold mirror 51 towards the objective lens 52 that is manually movable for manual focus adjustment. The window 50 protects the internal components of the optical assembly 59 from environmental elements. The light path 58 passes through the objective lens 52 to the combination penta/roof prism 53 where visible light reflects off a first 53.1 and second 53.2 edge towards a relay lens 56 and toward the user's eye 57. Infrared light, however, follows the light path 58 through a back facet dichroic coating on the back facet/side 54 of the combination penta/roof prism 53 towards a sensor 55 (e.g., a near infrared sensor). This back facet dichroic coating or filter 54 replaces the standard reflective coating (that is traditionally found in the art) on the back facet 54 of the combination penta/roof prism 53.

In some embodiments, the assembly 59 comprises a single moving objective lens 52 that allows for positional changes of the objective lens 52 in the horizontal plane relative to the light path 58 between the fold mirror 51 and the combination penta/roof prism 53. The image plane traversing the light path 58 is redirected and inverted internally by the combination penta/roof prism 53, where it is then relayed to a user's eye 57 often through an adjustable relay lens system 56.

According to some embodiments of the present invention, light 58 enters the glass window 50 where it is redirected to the objective lens 52 by the fold mirror 51. The objective lens 52 focuses the light to an image plane (not shown) internal to the combination penta/roof prism 53 having a dichroic long passfilter coating on the back facet 54 of the prism 53 which separates the incoming light on the light path 58 into two spectral bands—a first wavelength (e.g., infrared) and second wavelength (e.g., visible light). One band containing the second visible wavelength(s) reflects off back facet 54 similar to the reflective aluminum coating found in a standard combination penta/roof prism used manual focus units. The longer first wavelength(s) in the near infrared band of the spectrum is allowed to pass through the dichroic coating filter on the back 53.1 facet 54 and top 53.2 of the prism 53 and on to the image sensor 55. In some embodiments as shown in FIG. 3, this arrangement places the image sensor 55 in the same plane as the rest of the systems optical components thus preserving a slim package profile and inverting feature that allows the assembly 59 to be used with both a user's right and left eye 57. The visible light is then focused on to the retina of the observer eye 57 via the relay lens system 56.

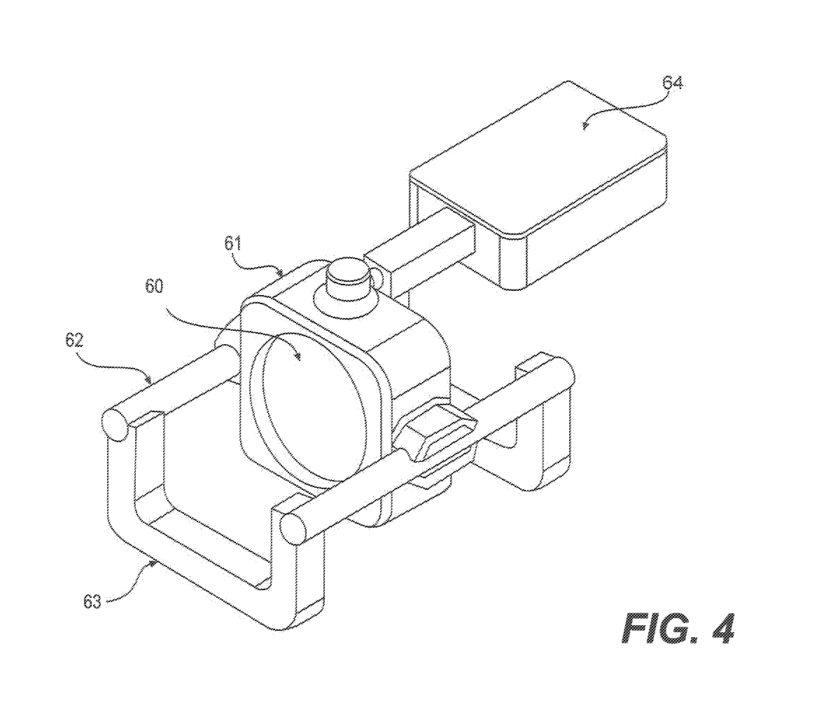

In some embodiments, the near infrared image of the observed object/scene is captured and processed via the assembly's micro-processor (not shown) to extract control signals that in turn drive a piezo actuator 64 as shown in FIG. 4. The objective lens 60 is housed in an objective lens carrier 61 which slides along guide rails 62 supported on each end by the guide rail supports 63 constraining the motion to a linear direction along the optical axis of the system and is driven by the piezo actuator 64. The objective lens 60 is driven (e.g., with a driving mechanism) in a selected direction and the near infrared image is processed to determine if the imaged scene is approaching focus or moving away from focus. The appropriate signal is then generated to activate the piezo actuator 64 which drives the objective lens 60, in the correct direction and distance to achieve a focused near infrared image on the image sensor which simultaneously focuses the visible image for the observer eye.

According to some embodiments of the present invention, the auto focus system replaces the manual rack and pinion manual mechanism with an electronically controlled actuator as shown in FIG. 4. The input signal for the actuator can be derived by software and/or one or more algorithms to determine edge sharpness in a selected region of interest and in addition, generate the required signals to drive the objective lens 60 to a focus inflection point.

In various embodiments of the focusing system of the present invention operating on near infrared light, the system and assembly of the present auto focus invention may also employ an infrared LED (not shown) for scene illumination in low ambient light conditions. In some embodiments, a dichroic coating can be applied to the fold mirror to allow the illumination LED to be placed behind the fold mirror 51 to reduce the package size further. The LED can also be mounted in the front of the unit to allow for broad area illumination.

In addition to the system and assembly, a method of auto focusing by filtering wavelengths for sensing is disclosed that includes receiving an image of an object, wherein the first image comprises a first wavelength and a second wavelength, wherein the first wavelength is passed through a dichroic filter to a sensor and the second wavelength reflected, analyzing the distance of the object based on the first wavelength, generating at least one signal to an objective lens subassembly comprising a drive mechanism arranged to displace an optical lens, and displacing an optical lens along an optical axis to focus the image.

One of ordinary skill in the art should appreciate that several methods may be used to determine the optical lens displacement producing the best focus. For example, embodiments of the present approach may incorporate a contrast-based algorithm to find the lens position providing an optimum focus. A sensor, such as a digital image sensor, may generate luminance data from the first wavelength. Luminance data may include, for instance, pixel intensity values representing the image in a two-dimensional plane having coordinates (x, y), Luminance data may be generated for a given displacement p of the optical lens, From the luminance data, a microprocessor may calculate mean intensity * and variance v using known statistical relationships. For example:

$$\begin{matrix}= \underline{\cdot \cdot } & ( 1 ) \\ = \underline{\cdot ( \cdot ) } & ( 2 )\end{matrix}$$

Embodiments using a contrast-based algorithm may calculate the slope of variance for changes in displacement p through, for example, linear regression:

$$= \overline{ ( ) } \qquad ( 3 )$$

When the slope of the variance readings against displacement reaches zero, the sharpest image (i.e., optimum focus) is achieved. Thus, embodiments may adjust the displacement of the lens until the slope is at or near zero. It should be appreciated that a threshold acceptable slope, such as zero plus/minus an acceptable amount, may be used in some embodiments. Alternatively, some embodiments may employ a continuous process, through which the lens displacement is continuously adjusted to improve focus. Of course, one of skill in the art should appreciate that other methods to determine the best focus using the first wavelength may be used without departing from the present approach.

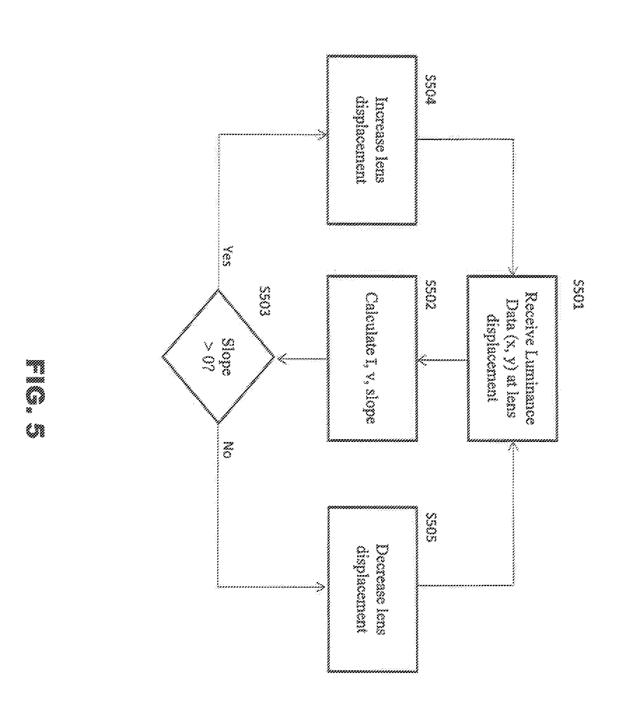

FIG. 5 is a flowchart showing an algorithm for focusing an image using first wavelength luminance data, according to some embodiments. This embodiment represents a simple control loop that may be used in some embodiments. The algorithm begins at S501, with the receipt of luminance data (x, y) from a first wavelength, at an initial lens displacement. As discussed above, luminance data may include pixel intensity of a two-dimensional image. Next, at S502, a microprocessor calculates mean intensity * and variance v, and then the slope, as discussed above. At S503, the control loop determines from the slope whether the current lens displacement represents an improvement in focus. For example, in this embodiment, a positive slope indicates that the change in lens displacement improved the focus. The control loop then, at S504, increases the lens displacement and repeats the loop. On the other hand, in this embodiment a negative slope indicates that the change in lens displacement did not improve the focus, and at S505 the control loop decreases the lens displacement and repeats the loops. It should be understood that the algorithm shown in FIG. 5 is merely an example, and that variations may be used without departing from the present method.

It is to be appreciated that any of the elements and features described herein may be combined with any one or more other elements and features.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. An automatic focusing optical system comprising:
an objective lens subassembly;
a sensor electronically connected to a processor; and
a dichroic filter for passing light of a first wavelength to the sensor and reflecting light of a second wavelength.

2. The optical system according to claim 1, wherein the objective lens subassembly further comprises a drive mechanism.

3. The optical system according to claim 2, wherein the drive mechanism is operatively connected to a processor.

4. The optical system according to claim 2, wherein the drive mechanism comprises a piezo actuator for receiving an electronic signal from the processor and displacing an objective lens of the objective lens subassembly.

5. The optical system according to claim 1, wherein the sensor is an infrared autofocus sensor.

6. The optical system according to claim 1, wherein the first wavelength comprises infrared light.

7. The optical system according to claim 1, wherein the second wavelength comprises visible light.

8. The optical system according to claim 1, further comprising a combination penta/roof prism.

9. The optical system according to claim 8, wherein the dichroic filter comprises a back facet dichroic coating on at least one side of the combination penta/roof prism.

10. The optical system according to claim 1, wherein the objective lens subassembly thriller comprises an adjustable focus lens.

11. An automatic focusing vision enhancing optical assembly comprising:
an objective lens subassembly;
an infrared sensor electronically connected to a processor;
an eyepiece lens; and
a dichroic filter for passing light of a first wavelength to the infrared sensor and reflecting light of a second wavelength towards the eyepiece lens.

12. The optical assembly according to claim 11, further comprising a combination penta/roof prism.

13. The optical assembly according to claim 12, wherein the dichroic filter comprises a back facet dichroic coating on at least one side of the combination penta/roof prism.

14. The optical assembly according to claim 11, wherein the objective lens subassembly further comprises a drive mechanism.

15. The optical assembly according to claim 14, wherein the drive mechanism is operatively connected to the processor.

16. The optical assembly according to claim 14, wherein the drive mechanism comprises a piezo actuator for receiving an electronic signal from the processor and displacing an objective lens of the objective lens subassembly.

17. The optical assembly according to claim 11, wherein the eyepiece lens is a relay lens.

18. A method of auto-focusing by filtering wavelengths for sensing, the method comprising:
receiving an image of an object, wherein the first image comprises a first wavelength and a second wavelength, wherein the first wavelength is passed through a dichroic filter to a sensor and the second wavelength reflected;
analyzing the distance of the object based on the first wavelength;
generating at least one signal to an objective lens subassembly comprising a drive mechanism arranged to displace an optical lens; and
displacing an optical lens along an optical axis to focus the image.

19. The method according to claim 18, wherein the sensor is an infrared sensor.

20. The method according to claim 18, wherein the first wavelength comprises infrared light.
